(19) United States
(12) Patent Application Publication
(10) Pub. No.: US 2012/0018108 A1
(43) Pub. Date: Jan. 26, 2012

(54) Safety window blind

(76) Inventor: Shih-Ming Lin, Chiayi Hsien (TW)

(21) Appl. No.: 12/805,230

(22) Filed: Jul. 20, 2010

(51) Int. Cl. F16G 11/10; A47H 5/02

(52) U.S. Cl. 160/340; 24/115 F

(57) ABSTRACT

A safety window blind includes a blind curtain hung from a headrail and having a plurality of anchored members on a rear major surface thereof, and a lift cord disposed rearwardly from the blind curtain, shielded by a cord shielding unit, and liftable to raise or lower the cord shielding unit. The cord shielding unit includes an elongated shell having first and second shell walls that are disposed opposite to each other relative to an upright axis. A lift-force transmitting unit has a force transmitting body with a gravity center located between the first and second shell walls, and an anchoring lug disposed to couple with the respective anchored member. A lifting force can transmit from the lift cord to the blind curtain through the lift-force transmitting units so as to divert most of the load of the blind curtain away from burdening a rather frail shell wall of the elongated shell.

### BACKGROUND OF THE INVENTION

1. Field of the Invention

This invention relates to a window blind, more particularly to a safety window blind with a cord shielding unit.

2. Description of the Related Art

FIG. 1 shows a conventional roman curtain which includes a curtain fabric 11, a plurality of engaging rings 12, and a plurality of cords 13. The engaging rings 12 are disposed on an inner side of the curtain fabric 11. The cords 13 are vertically disposed on the inner of the curtain fabric 11, and extend through the respective engaging rings 12. Lower ends of the cords 13 are connected to a lower portion of the curtain fabric 11 or to lowermost ones of the engaging rings 12.

When the curtain is in use, the curtain fabric 11 may be pulled up in a fold-on-fold manner by manipulation of an operating cord, or lowered in an unfolded state. However, strangulation or suffocation accidents may occur if a child gets chocked by the dangling cord 13 or the curtain fabric 11.

Referring to FIGS. 2 and 3, another conventional window blind 11 comprises a cord shielding member 14 which is disposed rearwardly of a roman curtain fabric 11 and which includes a plurality of stacked portions 141, and a plurality of connectors 15, each including a Velcro tape material or a C-shaped clasp, disposed to connect the cord shielding member 14 with the curtain fabric 11. The lift cords 13 are hidden in the cord shielding member 14, and are operable to extend or fold the cord shielding member 14 so as to lower or raise the curtain fabric 11. Since the cord shielding member 14 is made from a non-woven fabric material or a plastic sheet, and since the connectors 15 are each connected to the curtain fabric 11 and a pleat 142 of the respective stacked portion 141 so that the cord shielding member 14 bears the whole weight of the curtain fabric 11, the cord shielding member 14 may break during folding.

### SUMMARY OF THE INVENTION

An object of the present invention is to provide a safety window blind which has a reliable and durable cord shielding unit for shielding a lift cord.

According to this invention, the safety window blind includes a headrail, a blind curtain hung from the headrail, a plurality of anchored members mounted on a rear major surface of the blind curtain and spaced apart from one another in an upright direction, a lift cord, a cord shielding unit, and a plurality of lift-force transmitting units. The lift cord has a pulled cord segment which is disposed rearwardly from the rear major surface, and which has a terminal end that is weighted so as to tense the pulled cord segment in the upright direction. The pulled cord segment is suspended from the headrail and is liftable in the upright direction such that the terminal end is linearly displaceable between lower and raised positions by a lifting force applied to the lifting cord. The cord shielding unit includes an elongated shell which has first and second shell walls that are disposed opposite to each other relative to an axis in the upright direction and that cooperatively define an axial hole to permit passage of the pulled cord segment therethrough. The first and second shell walls extend in the upright direction to respectively terminate at first and second bottom wall ends that are coupled to and movable with the terminal end of the pulled cord segment. Each of the lift-force transmitting units has a force transmitting body disposed to transmit the lifting force in the upright direction, and an anchoring lug disposed on the force transmitting body. The force transmitting body has a gravity center located between the first and second shell walls. The anchoring lug extends outwardly of the cord shielding unit, and is disposed to couple with the respective anchored member so as to transmit the lifting force to the corresponding anchored member. Thus, the lifting force can transmit from the pulled cord segment to the blind curtain through the lift-force transmitting units so as to divert most of the load of the blind curtain away from burdening a rather frail shell wall of the elongated shell.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a conventional roman-type window blind;

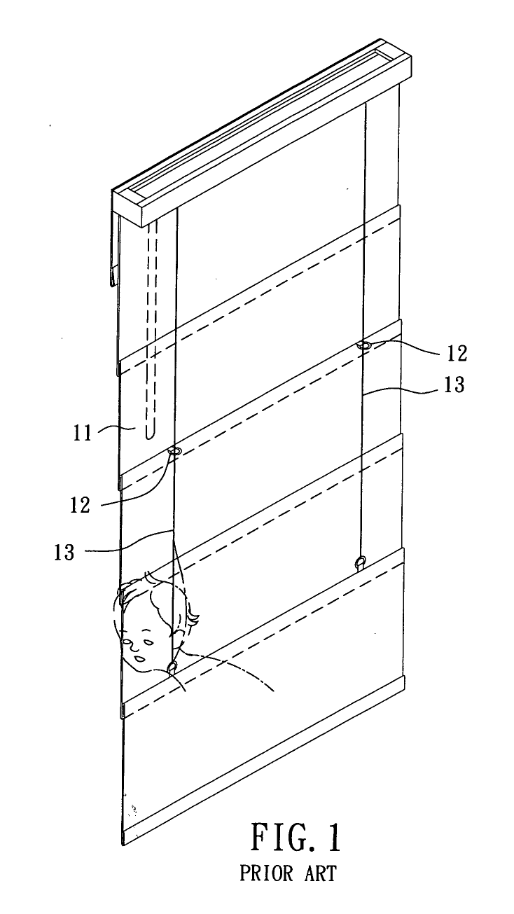

FIG. 2 is a perspective view of another conventional roman-type window blind;

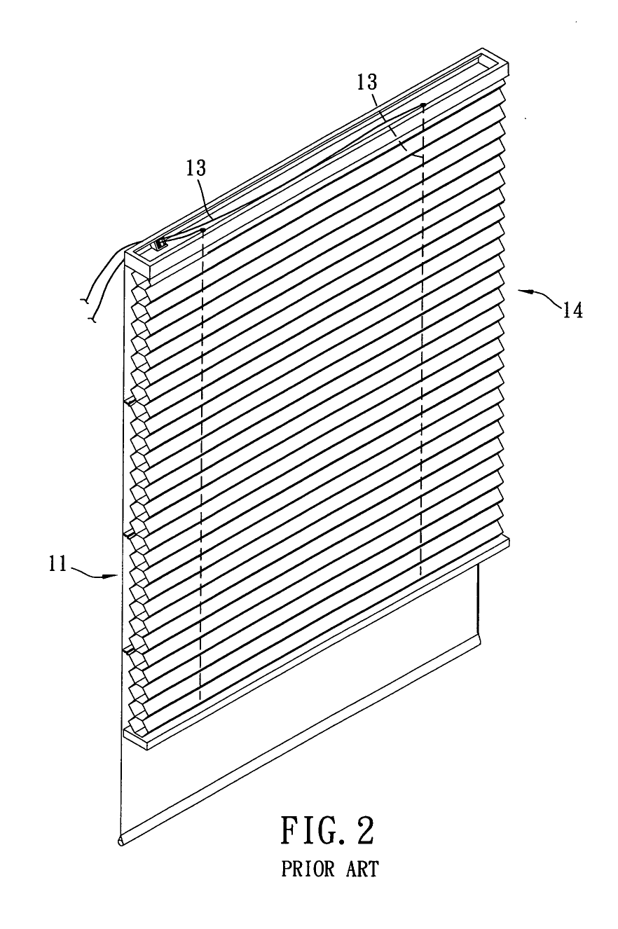

FIG. 3 is a fragmentary side view of the conventional roman-type window blind;

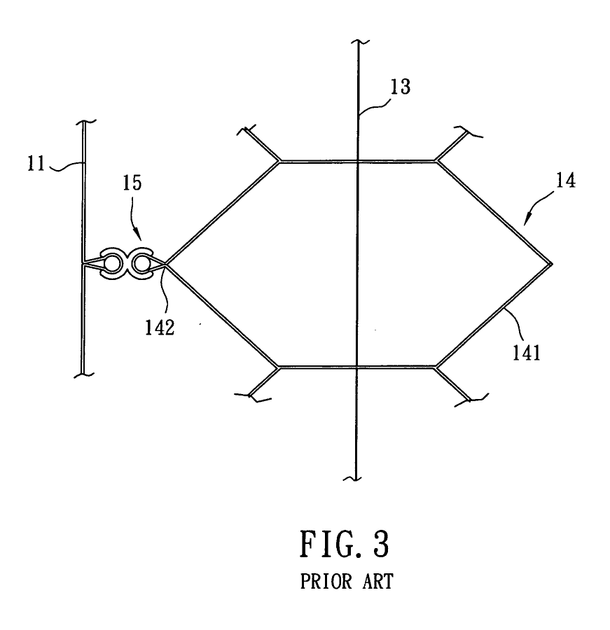

FIG. 4 is a perspective view of the first preferred embodiment of a safety window blind according to this invention viewed from a front side;

FIG. 5 is a perspective view of the first preferred embodiment viewed from a backside;

FIG. 6 is a fragmentary perspective view of a lifting unit of the first preferred embodiment;

FIG. 7 is a side view of the first preferred embodiment;

FIG. 8 is fragmentary exploded perspective view of the first preferred embodiment;

FIG. 9 is a perspective view of the second preferred embodiment of a safety window blind according to this invention viewed from a backside;

FIG. 10 is a side view of the second preferred embodiment;

FIG. 11 is a fragmentary exploded perspective view of the second preferred embodiment;

FIG. 12 is a perspective view of the third preferred embodiment of a safety window blind according to this invention viewed from a backside;

FIG. 13 is a fragmentary exploded perspective view of the third preferred embodiment;

FIG. 14 is a perspective view of the fourth preferred embodiment of a safety window blind according to this invention viewed from a backside;

FIG. 15 is a fragmentary exploded perspective view of the fourth preferred embodiment;

FIG. 16 is a fragmentary exploded perspective view of the fifth preferred embodiment of a safety window blind according to this invention; and

FIG. 17 is a fragmentary exploded perspective view of the sixth preferred embodiment of a safety window blind according to this invention.

### DETAILED DESCRIPTION OF THE PREFERRED EMBODIMENTS

Before the present invention is described in greater detail, it should be noted that same reference numerals have been used to denote like elements throughout the specification.

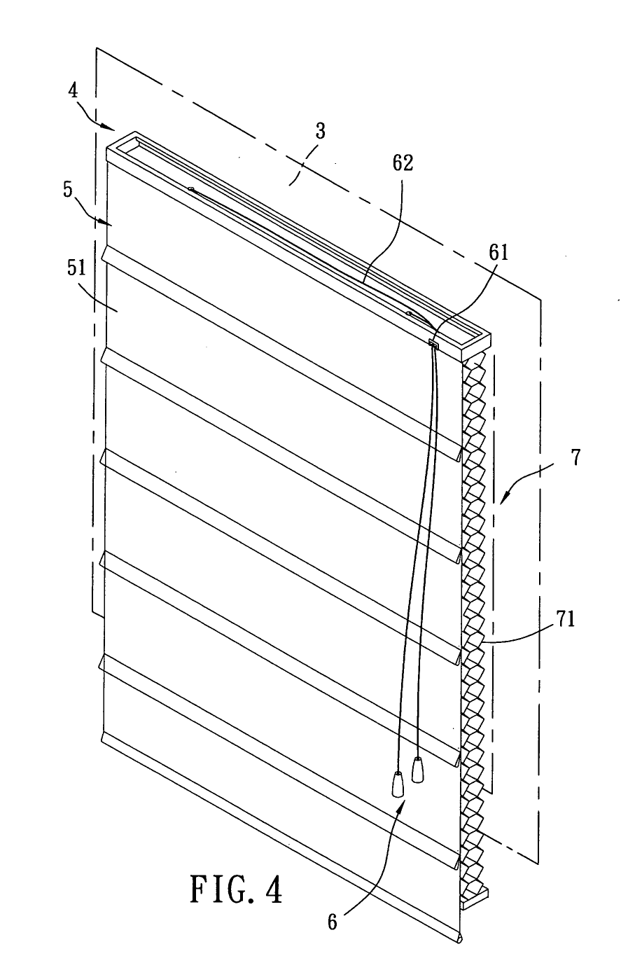

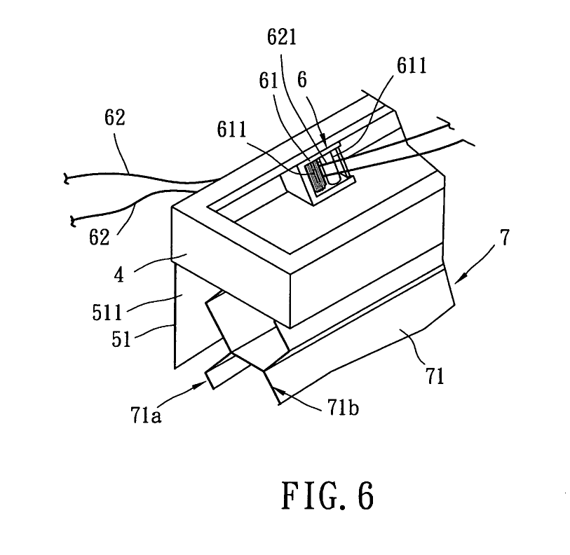

Referring to FIGS. 4 to 6, the first preferred embodiment of a safety window blind according to the present invention is shown to comprise a headrail 4 adapted to be mounted on an upper edge of a window 3, a primary blind unit 5, a lifting unit 6, a cord shielding unit 7, and a plurality of lift-force transmitting units 9.

The primary blind unit 5 includes a primary blind curtain 51 having an upper end portion connected to the headrail 4 and hung from the headrail 4, and a rear major surface 511, and a plurality of first anchored members 52, such as three pairs of anchored members 52, mounted on the rear major surface 511 and spaced apart from one another in an upright direction.

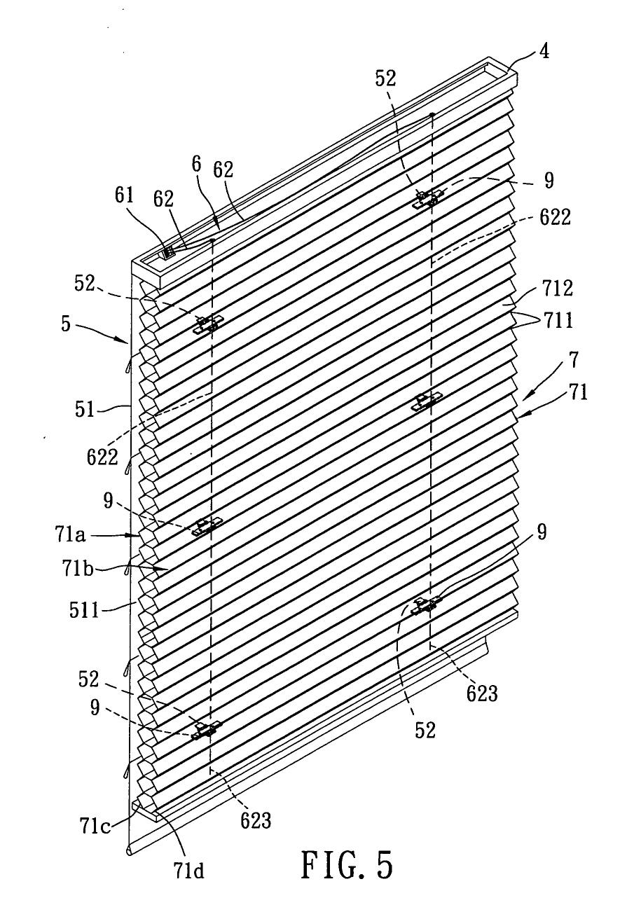

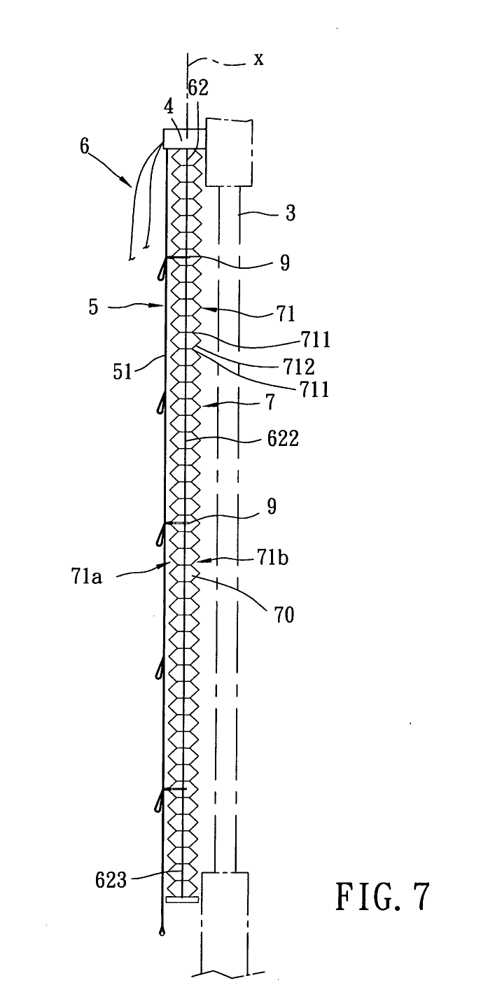

Referring to FIGS. 5 to 7, the lifting unit 6 includes a positioning member 61 and two lift cords 62. The positioning member 61 has two rollers 611 disposed on the headrail 4 to permit passage of a front cord segment 621 of each lift cord 62 therethrough for retaining engagement. Each lift cord 62 has a pulled cord segment 622 disposed rearwardly from the rear major surface 511, and having a terminal end 623 that is weighted so as to tense the pulled cord segment 622 in the upright direction. Thus, the pulled cord segment 622 is suspended from the headrail 4 and is liftable in the upright direction such that the terminal end 623 is linearly displaceable between lower and raised positions by a lifting force applied to the front cord segment 621.

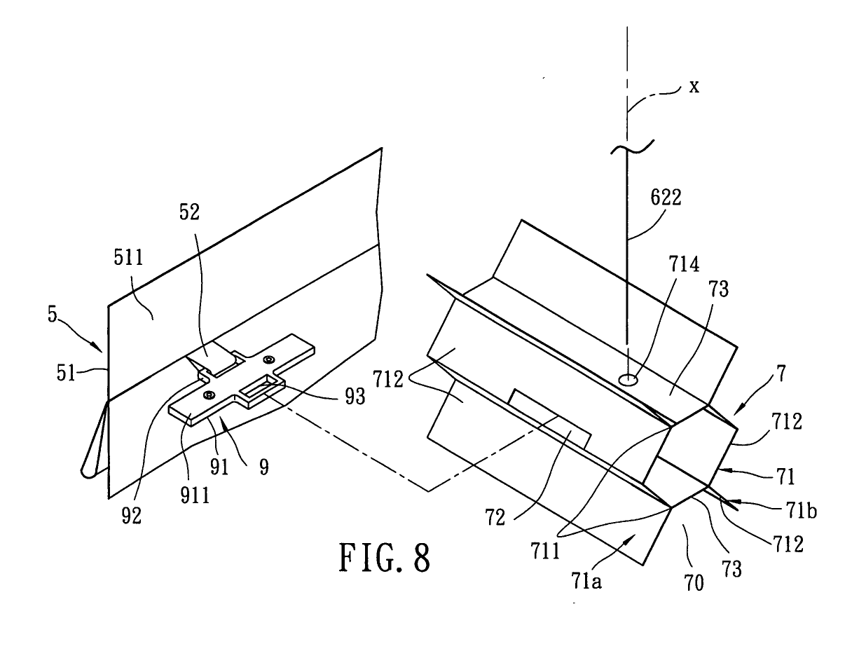

Referring to FIGS. 5, 7 and 8, the cord shielding unit 7 includes an elongated shell 71 which has first and second shell walls (71a, 71b) that are disposed opposite to each other relative to an axis (X) in the upright direction and that cooperatively define an axial hole 70 to permit passage of the pulled cord segment 622 therethrough. The first and second shell walls (71a,71b) extend in the upright direction to respectively terminate at first and second bottom wall ends (71c,71d) that are coupled to and movable with the terminal ends 623 of the lift cords 62. In this embodiment, the first and second shell walls (71a,71b) are disposed opposite to each other in a forward-and-rearward direction. Each of the first and second shell walls (71a,71b) has a plurality of stage regions 711 displaced from one another along the axis (X), and a plurality of foldable regions 712 disposed alternately to the stage regions 711. Hence, when the terminal ends 623 of the lift cords 62 are moved from the lower position to the raised position, the lowermost ones of the foldable regions 712 of the first and second shell walls (71a, 71b) are folded axially and the lowermost ones of the staged regions 711 are lifted to adjoin sequentially the higher ones of the stage regions 711 until the selected ones of the stage regions are reached. The cord shielding unit 7 may further have a plurality of web members 73, each spanning between two corresponding stage regions 711 of the first and second shell walls (71a,71b), and having a through hole 714 which is registered with the axial hole 70 for passage of the pulled cord segment 622.

Each lift-force transmitting unit 9 has a force transmitting body 91 and a front anchoring lug 92. The force transmitting body 91 has a gravity center located between the first and second shell walls (71a, 71b), and is disposed to transmit the lifting force in the upright direction. The front anchoring lug 92 which is disposed on the force transmitting body 91, extends outwardly of the cord shielding unit 7, and is disposed to couple with the respective first anchored member 52 so as to transmit the lifting force to the corresponding first anchored member 52. In this embodiment, the force transmitting body 91 of each lift-force transmitting unit 9 is disposed in the axial hole 70, and has a major wall 911 extending in the forward-and-rearward direction to terminate at proximate and distal sides and having a passage 93 that extends in the upright direction and that is registered with the through hole 714 for passage of the pulled cord segment 622 therethrough. The front anchoring lug 92 extends forwardly from and is integrally formed with the proximate side of the major wall 911 to project outwardly of the first shell wall (71a) through an opening 72 so as to engage the respective first anchored member 52.

Since the pulled cord segments 622 of the lift cord 62 can be shielded in the axial hole 70 of the cord shielding unit 7, strangulation accidents can be prevented. In addition, by virtue of the provision of the lift-force transmitting units 9 in the axial hole 70 to placed its gravity center between the first and second shell walls (71a, 71b), and by engagement of the pulled cord segments 622 with the lift-force transmitting units 9, the lifting force can transmit from the pulled cord segments 622 to the primary blind curtain 51 through the lift-force transmitting units 9 so as to divert most of the load of the primary blind curtain 51 away from overburdening rather frail shell walls of the elongated shell 71.

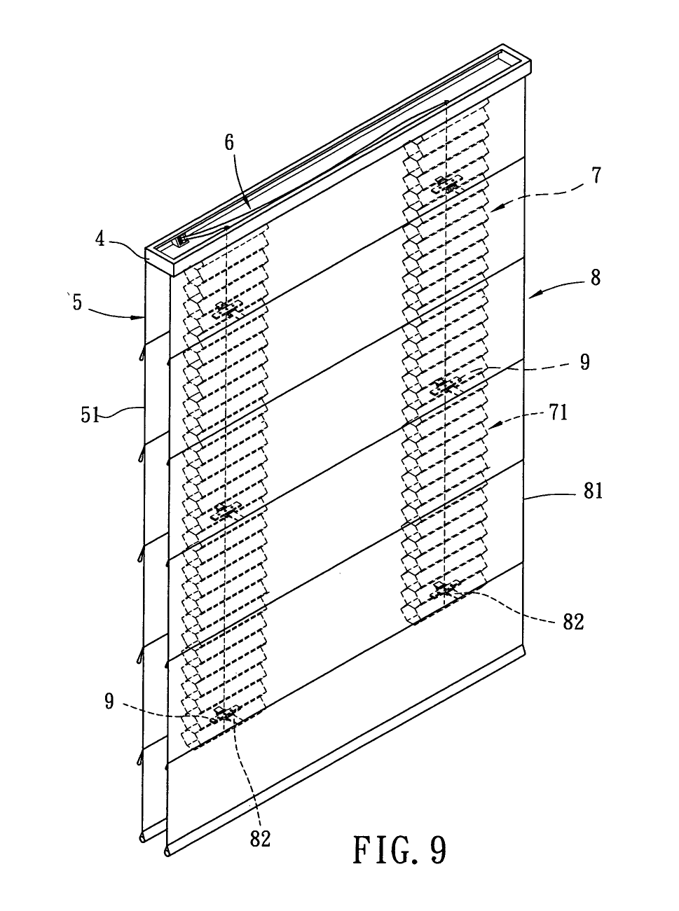

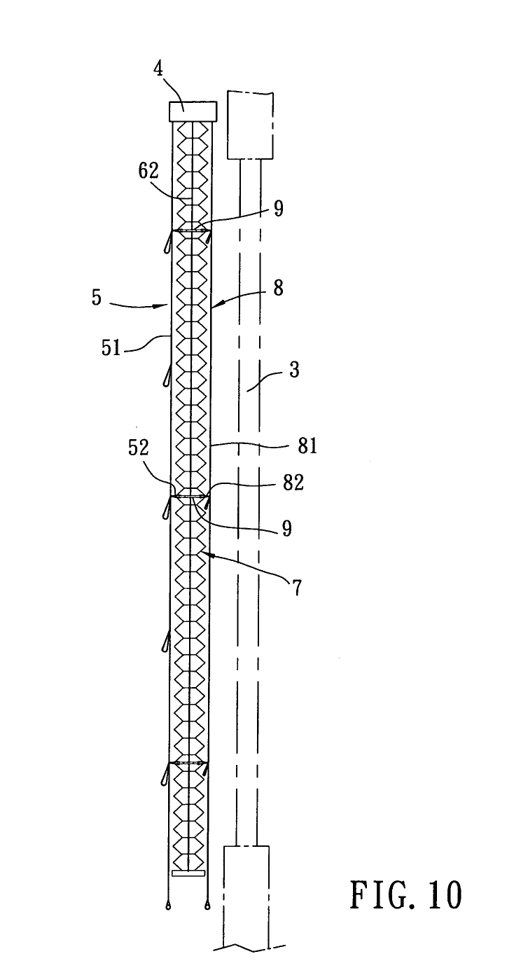

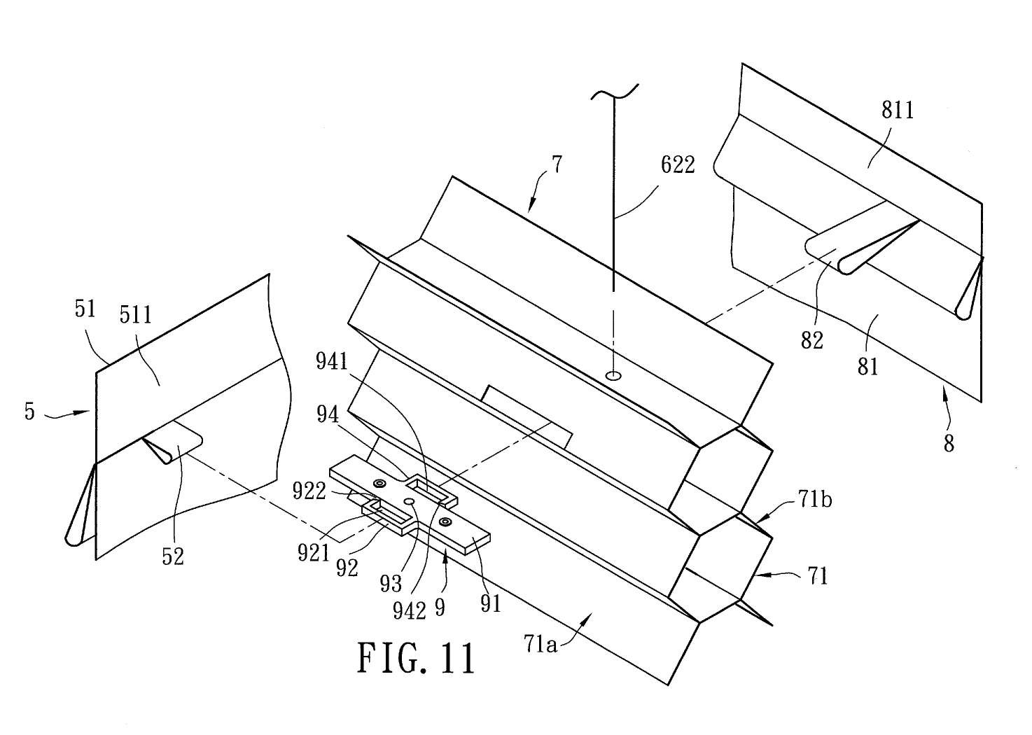

Referring to FIGS. 9 to 11, the second preferred embodiment of a safety window blind according to this invention is similar to that of the previous embodiment in construction. In the second embodiment, the window blind further comprises a secondary blind unit 8 which includes a secondary blind curtain 81 and a plurality of second anchored members 82. The secondary blind curtain 81 is hung from the headrail 4, and has a front major surface 811 disposed rearwardly of and spaced apart from the cord shielding unit 7. The second anchored members 82 are mounted on the front major surface 811 and are spaced apart from one another in the upright direction. In addition, each lift-force transmitting unit 9 further has a rear anchoring lug 94 extending from and integrally formed with the distal side of the force transmitting body 91 and outwardly of the second shell wall (71b) so as to couple with the respective second anchored member 82 to transmit the lifting force to the corresponding second anchored member 82. Additionally, each of the front and rear anchoring lugs 92,94 has a slot 921,941 and a slit 922,942 communicated with the slot 921,941 such that a respective one of the first and second anchored members 52,82 is insertable into the slot 921,941 through the slit 922,942. Accordingly, in use, each lift-force transmitting units 9 can selectively disengage from the rear second anchored member 82 such that, when the lift cords 62 are moved to the raised position, only the primary blind curtain 51 is raised so that the secondary blind curtain 81, which may be made from a thin translucent fabric, is kept in a lower position for thinly veiling the window 3. Alternatively, the primary and secondary blind curtains 51,81 can be together raised by means of the lift cords 62.

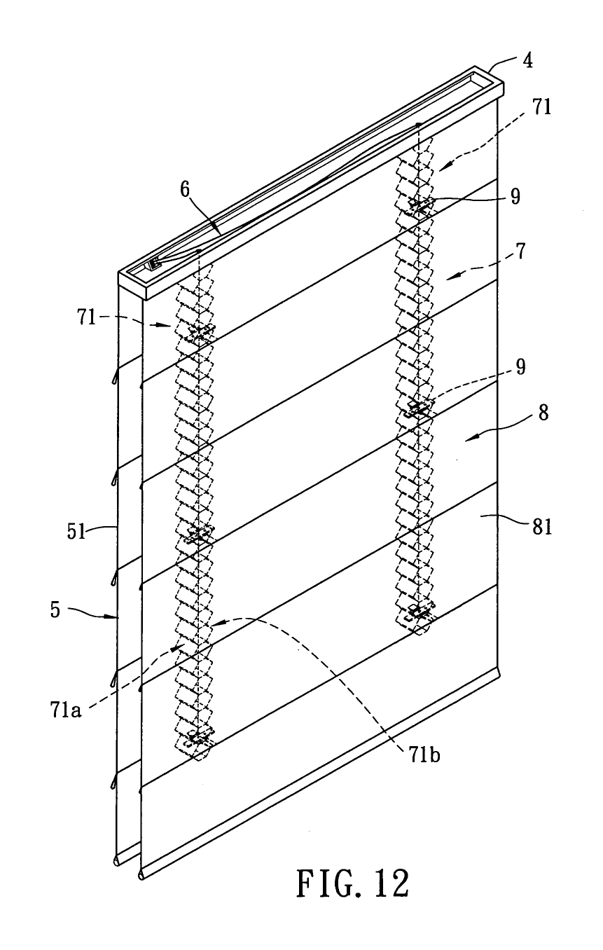

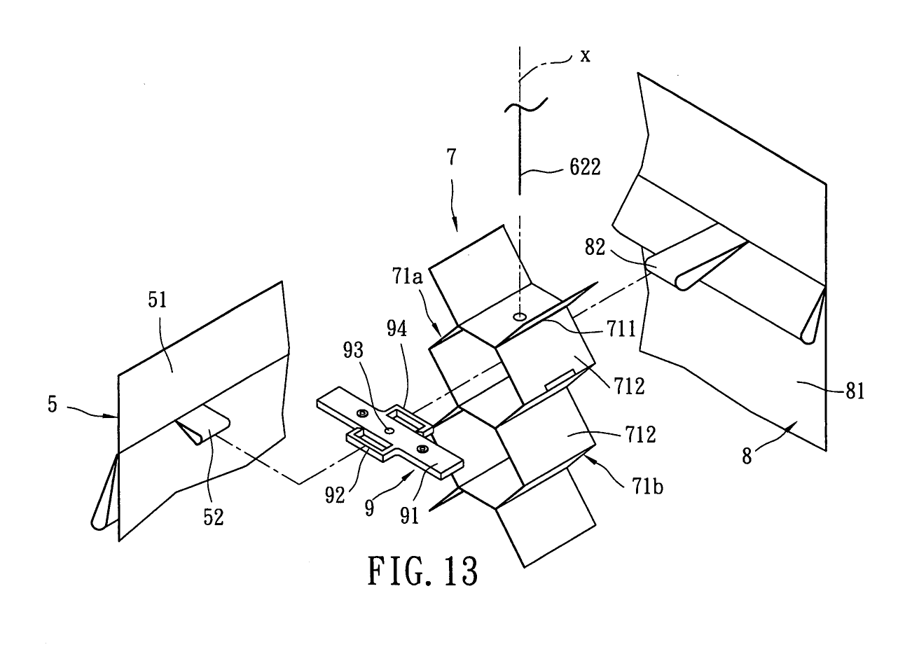

Referring to FIGS. 12 and 13, the third preferred embodiment of the safety window blind according to this invention is similar to that of the second embodiment. In the third embodiment, the cord shielding unit 7 includes two elongated shells 71, each having first and second shell walls (71a,71b) are disposed opposite to each other in a leftward-and-rightward direction.

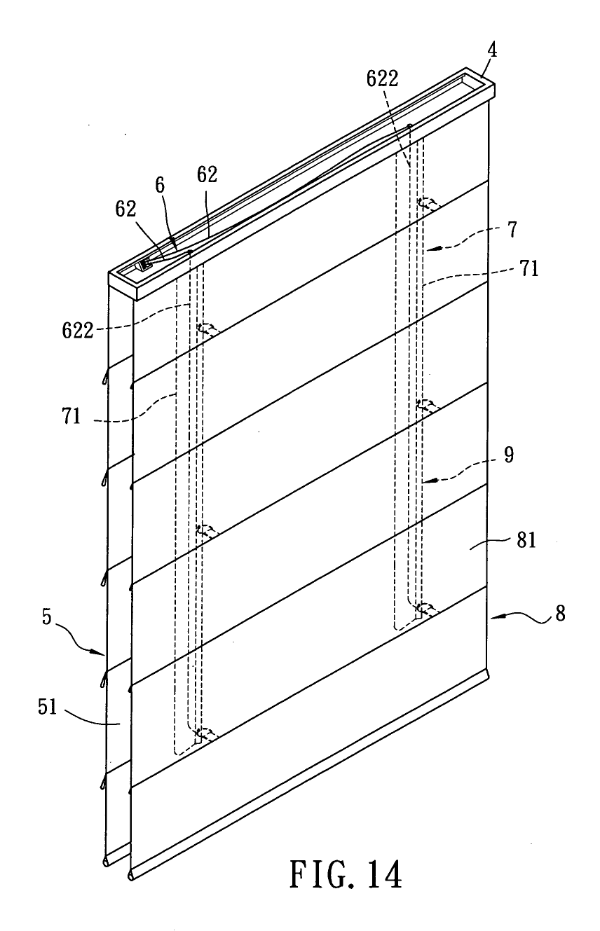

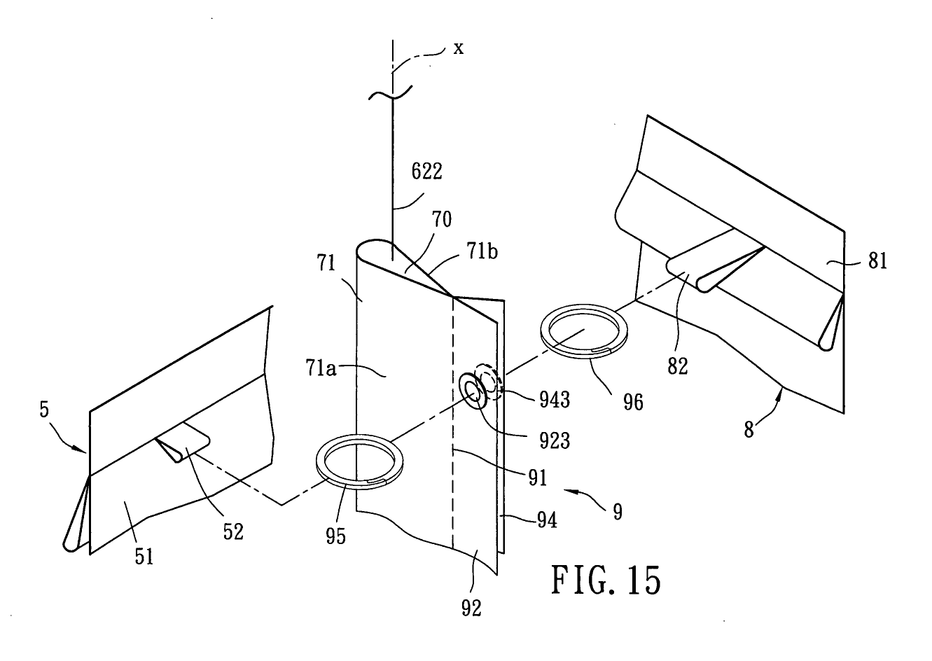

FIGS. 14 and 15 show the fourth preferred embodiment of the safety window blind according to this invention in which the cord shielding unit 7 includes two elongated shells 71 each formed by a web of fabric that is looped around the axis (X) to have the first and second shell walls (71a, 71b). The first and second shell walls (71a, 71b) respectively have two uprightly extending ends joined together to serve as the force transmitting bodies 91 of the lift-force transmitting units 9. The front anchoring lugs 92 and the rear anchoring lugs 94 extend from and are integrally formed with the two uprightly extending ends, and respectively have a plurality of eyelets 923,943. Each lift-force transmitting units 9 further has front and rear rings 95,96 configured to detachably couple the respective one of the first and second anchored members 52,82 with a respective one of the eyelets 923,943. Since the elongated shells 71 are made from a flexible fabric which is foldable and collapsible so as to transmit the lifting force from the lift cords 62 to the primary and secondary blind curtains 51,81 to raise or lower the same, and which has a great structural strength to sustain the weights of the curtains 51,81.

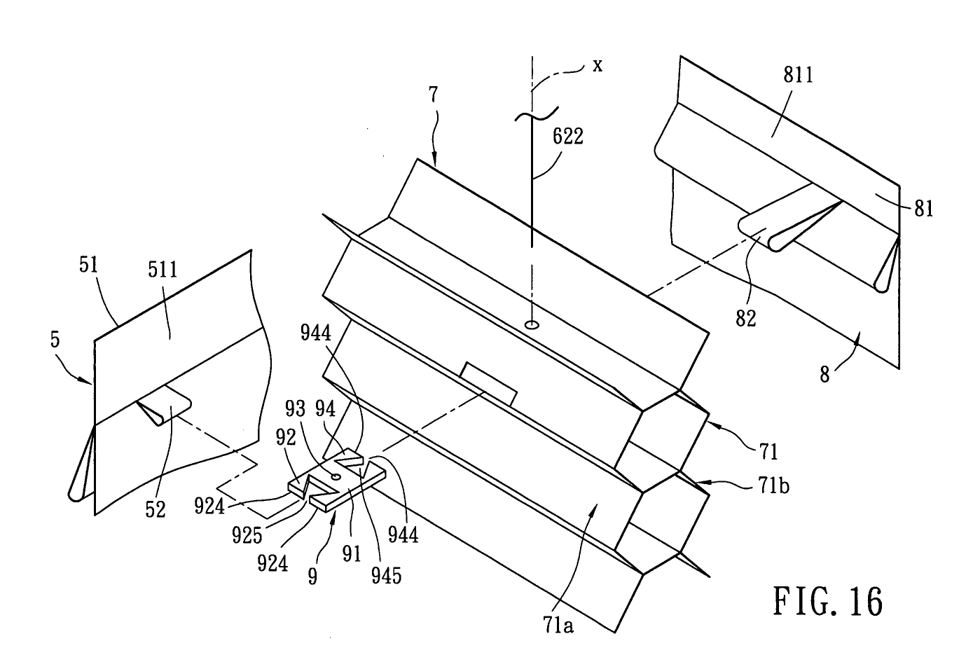

Referring to FIG. 16, the fifth preferred embodiment of the safety window blind according to this invention is similar to that of the second preferred embodiment in construction. In the fifth embodiment, each of the front and rear anchoring lugs 92,94 has a pair of hooks 924,944 respectively. Each pair of the hooks 924, 944 have hook ends spaced apart from each other by an insertable gap 925,945 so as to permit a respective one of the front and rear anchoring lugs 92,94 to be detachably hooked on the respective one of the first and second anchored members 52,82. Thus, if it is required for various reasons to promptly separate either one of the primary and secondary blind curtains 51,81 from the elongated shell 71, by virtue of simply tilting the respective anchoring lug 92, 94 aside, the first and second anchored members 52,82 can be easily removed from the respective front or rear anchoring lugs 92, 94.

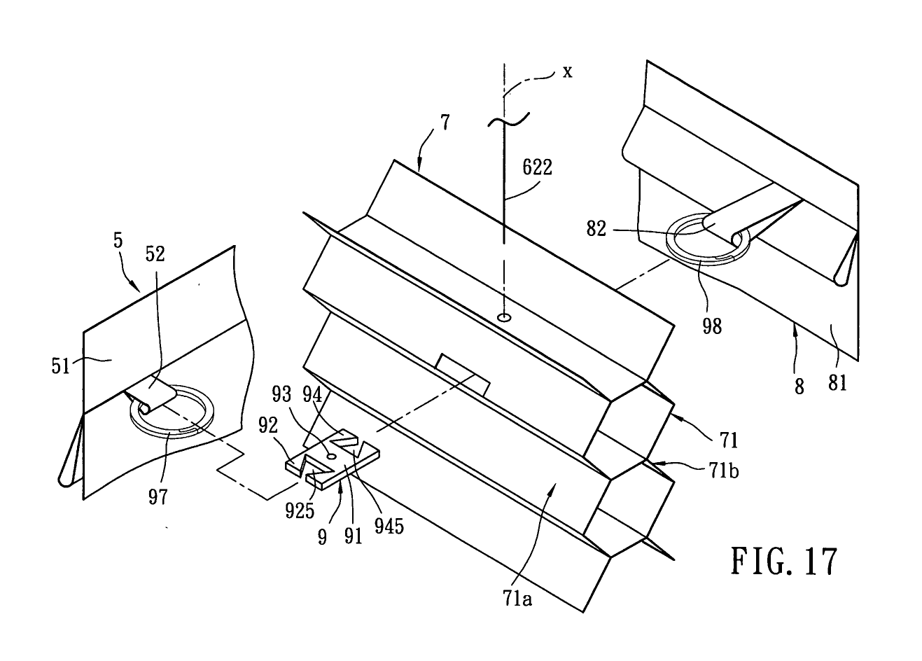

Referring to FIG. 17, in the sixth preferred embodiment that is similar to the fifth preferred embodiment, each of the lift-force transmitting units 9 further has first and second rings 97,98 configured to detachably couple a respective one of the first and second anchored members 52,82 with a respective one of the insertable gaps 925, 945.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A safety window blind comprising:
a headrail;
a primary blind curtain having an upper end portion connected to said headrail and hung from said headrail, said primary blind curtain having a rear major surface;
a plurality of first anchored members mounted on said rear major surface and spaced apart from one another in an upright direction;
a lift cord having a pulled cord segment which is disposed rearwardly from said rear major surface, and which has a terminal end that is weighted so as to tense said pulled cord segment in the upright direction, said pulled cord segment being suspended from said headrail and liftable in the upright direction such that said terminal end is linearly displaceable between lower and raised positions by a lifting force which is applied to said lifting cord;
a cord shielding unit including an elongated shell which has first and second shell walls that are disposed opposite to each other relative to an axis in the upright direction and that cooperatively define an axial hole to permit passage of said pulled cord segment therethrough, said first and second shell walls extending in the upright direction to respectively terminate at first and second bottom wall ends that are coupled to and movable with said terminal end; and
a plurality of lift-force transmitting units, each having
a force transmitting body having a gravity center which is located between said first and second shell walls, and disposed to transmit the lifting force in the upright direction, and
a front anchoring lug which is disposed on said force transmitting body, which extends outwardly of said cord shielding unit, and which is disposed to couple with a respective one of said first anchored members so as to transmit the lifting force to a corresponding one of said first anchored members.

2. The safety window blind according to claim 1, wherein each of said first and second shell walls has a plurality of stage regions which are displaced from one another along the axis, and which are axially adjoinable one after another such that when said terminal end is moved from the lower position to the raised position, the lowermost one of said staged regions of each of said first and second shell walls is lifted to adjoin sequentially higher ones of said stage regions until a selected one of said stage regions is reached.

3. The safety window blind according to claim 2, wherein each of said first and second shell walls has a plurality of foldable regions which are disposed alternately to said stage regions such that, when one of said foldable regions is folded axially, the adjacent two of said stage regions are brought to adjoin each other.

4. The safety window blind according to claim 3, wherein said cord shielding unit includes a plurality of web members, each spanning between two corresponding stage regions of said first and second shell walls, and having a through hole which is registered with said axial hole.

5. The safety window blind according to claim 1, wherein said force transmitting body of each of said lift-force transmitting units has a major wall which extends in a direction transverse to the upright direction to terminate at proximate and distal sides and which has a passage extending in the upright direction for passage of said pulled cord segment therethrough, said front anchoring lug extending from said proximate side towards said rear major surface of said primary blind curtain.

6. The safety window blind according to claim 5, further comprising:
a secondary blind curtain hung from said headrail, and having a front major surface disposed rearwardly of and spaced apart from said cord shielding unit; and
a plurality of second anchored members mounted on said front major surface and spaced apart from one another in the upright direction;
each of said lift-force transmitting units further having a rear anchoring lug which extends from said distal side of said force transmitting body and outwardly of said cord shielding unit, and which is configured to couple with a respective one of said second anchored members so as to transmit the lifting force to a corresponding one of said second anchored members.

7. The safety window blind according to claim 6, wherein said front anchoring lug and said rear anchoring lug being integrally formed with said major wall.

8. The safety window blind according to claim 7, wherein each of said front and rear anchoring lugs has a slot and a slit communicated with said slot such that a respective one of said first and second anchored members is insertable into said slot through said slit.

9. The safety window blind according to claim 7, wherein each of said front and rear anchoring lugs has a pair of hooks respectively having hook ends which are spaced apart from each other by an insertable gap so as to permit a respective one of said front and rear anchoring lugs to be detachably hooked on the respective one of said first and second anchored members.

10. The safety window blind according to claim 1, wherein said first and second shell walls are disposed opposite to each other in a forward-and-rearward direction.

11. The safety window blind according to claim 1, wherein said first and second shell walls are disposed opposite to each other in a leftward-and-rightward direction.

12. The safety window blind according to claim 1, wherein said elongated shell is formed by a web of fabric which is looped around the axis to have said first and second shell walls that respectively have two uprightly extending ends joined together to serve as said force transmitting bodies of said lift-force transmitting units, said front anchoring lugs extending from and being integrally formed with one of said uprightly extending ends, and having a plurality of eyelets, each of said lift-force transmitting units further having a ring configured to detachably couple the respective one of said first anchored member with a respective one of said eyelets.
